(19) United States
(12) Patent Application Publication
(10) Pub. No.: US 2017/0047025 A1
(43) Pub. Date: Feb. 16, 2017

(54) LIQUID CRYSTAL DISPLAY DEVICE

(71) Applicant: SAMSUNG DISPLAY CO., LTD., Yongin-si (KR)

(72) Inventors: Hui Gyeong YUN, Asan-si (KR); Ji Ho MOON, Cheonan-si (KR)

(21) Appl. No.: 15/000,526

(22) Filed: Jan. 19, 2016

(30) Foreign Application Priority Data
Aug. 11, 2015 (KR) 10-2015-0113089

(51) Int. Cl. G09G 3/36; G02F 1/1343; G02F 1/1362

(52) U.S. Cl. CPC G09G 3/3607; G02F 1/136286; G02F 1/134309; G09G 3/3677; G09G 3/3688; G02F 2001/13629; G02F 2001/134345; G09G 2300/0452; G09G 2300/0426; G09G 2300/0814

(57) ABSTRACT

A liquid crystal display device includes a gate driver connected to an ith gate line, a first storage line is in a same layer as the ith gate line, and a display panel having first and second pixel units connected to the ith gate line. The first pixel unit includes a first high switch, a first low switch, and a first distribution switch connected to the ith gate line. The second pixel unit includes a second high switch, a second low switch, and a second distribution switch connected to the ith gate line. The first distribution switch is connected to the first low switch and a second storage line. The second distribution switch is connected to the second low switch and the second storage line. The second storage line is in a different layer from the first storage line and is connected to the first storage line.

### CROSS-REFERENCE TO RELATED APPLICATION

Korean Patent Application No. 10-2015-0113089, filed on Aug. 11, 2015, and entitled, “Liquid Crystal Display Device,” is incorporated by reference herein in its entirety.

### BACKGROUND

1. Field

One or more embodiments herein relate to a liquid crystal display device.

2. Description of the Related Art

A liquid crystal display device may be formed by interposing a liquid crystal layer between two substrates that respectively include pixel electrodes and a common electrode. When voltages are applied to the electrodes, an electric field is generated which controls the alignment direction of liquid crystal molecules in the liquid crystal layer. As a result, the polarization of incident light is controlled to display images.

Various types of liquid crystal display devices have been developed. In a vertically aligned mode liquid crystal display device, major axes of the liquid crystal molecules are aligned vertically relative to display panels in the absence of electric field. In this device, one pixel may be divided into two sub pixels for side visibility.

### SUMMARY

In accordance with one or more embodiments, a liquid crystal display device includes a gate driver connected to an ith gate line; a first storage line in a same layer as the ith gate line; and a display panel having first and second pixel units connected to the ith gate line, wherein the first pixel unit includes a first high switch, a first low switch and a first distribution switch connected to the ith gate line, and the second pixel unit includes a second high switch, a second low switch, and a second distribution switch connected to the ith gate line, wherein the first distribution switch has a first electrode connected to the first low switch and a second electrode connected to a second storage line, and the second distribution switch has a first electrode connected to the second low switch and a second electrode connected to the second storage line, and wherein the second storage line is in a different layer from the first storage line and is connected to the first storage line.

The second storage line may be connected to the first storage line through at least one contact hole. The same voltage may be applied to the first and second storage lines. The first high switch may have a first electrode connected to a jth data line and a second electrode connected to a first sub pixel electrode, the first low switch may have a first electrode connected to the jth data line and a second electrode connected to a second sub pixel electrode, the second high switch may have a first electrode connected to a kth data line and a second electrode connected to a third sub pixel electrode, and the second low switch may have a first electrode connected to the kth data line and a second electrode connected to a fourth sub pixel electrode. The kth data line may be between the first high switch and the second high switch.

The data signal may be applied to the jth data line and a data signal may be applied to the kth data line have different polarities. The second storage line may be in a same layer as at least one of the first to fourth sub pixel electrodes. At least part of the second storage line may overlap the jth and kth data lines.

In accordance with another embodiment, a liquid crystal display device may include a gate driver connected to a plurality of gate lines; a data driver connected to a plurality of data lines; a first storage line in a same layer as the gate lines; and a display panel having a plurality of pixel units including first to third switches connected to an ith gate line among the gate lines, wherein each of the pixel units includes a high pixel electrode connected to a first electrode of the first switch and a low pixel electrode connected to a first electrode of the second switch, wherein the third switch in the pixel units has a first electrode connected to a first electrode of the second switch and a second electrode connected to a second storage line, and the second storage line is in a different layer from the first storage line and connected to the first storage line.

The first storage line may be connected to the second storage line through at least one contact hole. The first and second storage lines may receive a same voltage. The pixel units may be connected to respective ones of the data lines, the pixel units may include a first pixel unit connected to a jth data line and a second pixel unit connected to a j+1th data line, and the first storage line may be connected to the second storage line through a contact hole in at least one of the first pixel unit or the second pixel unit. The jth data line and the j+1th data line may receive data signals having different polarities. At least part of the second storage line may overlap the jth data line and the j+1th data line.

In accordance with one or more other embodiments, a liquid crystal display device includes a first pixel unit having a first high pixel unit to apply a jth data signal to a first sub pixel electrode in response to an ith gate signal, and a first low pixel unit to apply the jth data signal and a storage signal to a second sub pixel electrode in response to the ith gate signal; a second pixel unit having a second high pixel unit to apply a kth data signal to a third sub pixel electrode in response to the ith gate signal, and a second low pixel unit to apply the kth data signal and the storage signal to a fourth sub pixel electrode in response to the ith gate signal; a first storage line connected to the first and second low pixel units, the first storage line to provide the storage signal; and a second storage line in a different layer from a layer of the first storage line, the second storage line connected to the first storage line.

The second storage line may be in a same layer as the first to fourth sub pixel electrodes, and the first storage line may be in a same layer as a layer of an ith gate line which is to provide the ith gate signal. The first storage line and the second storage line may receive a same voltage. The first storage line and the second storage line may be electrically connected through at least one contact hole. The device may include a gate driver connected to an ith gate line which is to provide the ith gate signal; and a data driver connected respectively to a jth data line which is to provide the jth data signal and a kth data line which is to provide the kth data signal.

The first low pixel unit may include a first low switch having a gate electrode connected to the ith gate line, a first electrode connected to the jth data line, and a second electrode connected to the second sub pixel electrode, and a first distribution switch having a gate electrode connected to the ith gate line, a first electrode connected to the second sub pixel electrode, and a second electrode connected to the second storage line, and the second low pixel unit may include a second low switch having a gate electrode connected to the ith gate line, a first electrode connected to the kth data line, and a second electrode connected to the fourth sub pixel electrode, and a second distribution switch having a gate electrode connected to the ith gate line, a first electrode connected to the fourth sub pixel electrode, and a second electrode connected to the second storage line.

### BRIEF DESCRIPTION OF THE DRAWINGS

Features will become apparent to those of skill in the art by describing in detail exemplary embodiments with reference to the attached drawings in which:

FIG. 1 illustrates an embodiment of a liquid crystal display device;

FIG. 2 illustrates an embodiment of region A in FIG. 1;

FIG. 3 illustrates a pixel unit;

FIGS. 4 to 6 illustrate another embodiment of a pixel unit;

FIG. 7 illustrates a layout embodiment of region A;

FIG. 8 illustrates a cross-sectional view taken along line I1-I1′ of FIG. 7;

FIG. 9 illustrates a cross-sectional view taken along line I2-I2′ of FIG. 7;

FIG. 10 illustrates a cross-sectional view taken along line I3-I3′ of FIG. 7;

FIGS. 11 to 13 illustrate an embodiment of a method for forming region A; and

FIGS. 14(a) and 14(b) illustrate examples of effects of a liquid crystal display.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments.

It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present between the element and the another element. In contrast, when an element is referred to as being “directly on”, “directly connected to” or “directly coupled to” another element or layer, there are no intervening elements or layers present between the element and the another element. As used herein, the term “and/or” includes any and all combinations of one or more of the associated listed items.

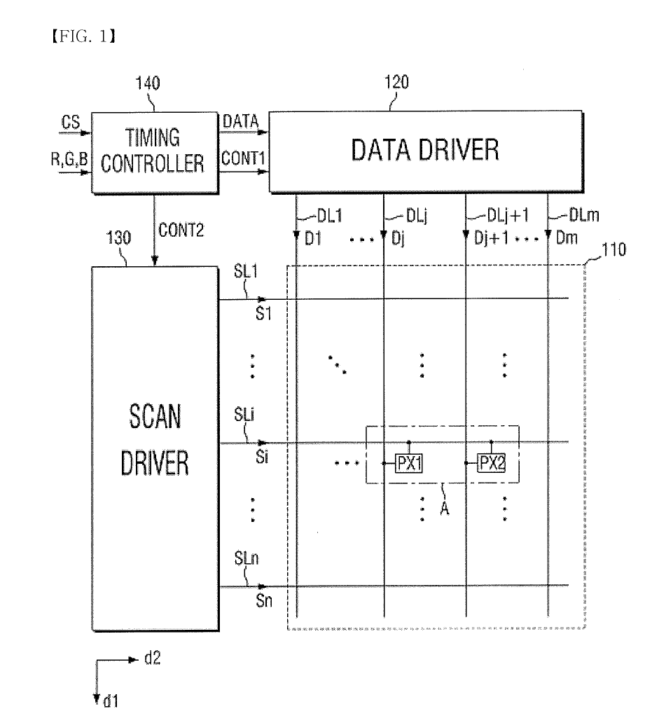

FIG. 1 illustrates an embodiment of a liquid crystal display device which includes a display panel 110, a data driver 120, a gate driver 130 and a timing controller 140. The display panel 110 includes a liquid crystal layer 30 between a lower display plate 10 and an upper display plate 20. The display panel 110 is a liquid crystal display panel connected to a plurality of gate lines SL1 to SLn and a plurality of data lines DL1 to DLm. The display panel 110 includes a plurality of pixel units connected to the gate lines SL1 to SLn and the data lines DL1 to DLm. The gate lines SL1 to SLn, the data lines DL1 to DLm, and the pixel units PXs may be formed on the lower display plate 10 of the display panel 110, and the lines are insulated from each other.

The pixel units PXs may be arranged into, for example, a matrix. The data lines DL1 to DLm extend, for example, in a first direction d1 on the lower display plate 10. The gate lines SL1 to SLn extend in a second direction d2 intersecting the first direction d1. Referring to FIG. 1, the first direction d1 may be, for example, a row direction and the second direction d2 may be a column direction. The pixel units PXs receive data signals from the data lines DL1 to DLm in response to gate signals from the gate lines SL1 to SLn.

The data driver 120 may include, for example, a shift register, a latch, and a digital-analog converter DAC. The data driver 120 receives the first control signal CONT1 and image data DATA from the timing controller 140. The data driver 120 selects a reference voltage in response to the first control signal CONT1, and converts digital waveform image data DATA corresponding to the data signals D1 to Dm based on the selected reference voltage. The data driver 120 provides the data signals D1 to Dm to the display panel 110.

The gate driver 130 receives the second control signal CONT2 from the timing controller 140. The gate driver 130 provides gate signals S1 to Sn to the display panel 110 according to the second control signal CONT2.

The timing controller 140 receives image signals R, G and B and a control signal CS from an external source. The control signal CS may include, for example, a vertical synchronous signal Vsync, a horizontal synchronous signal Hsync, a main clock signal MCLK, and a data enable signal DE. The timing controller 140 processes signals from an external source to be appropriate to the operating conditions of the display panel 110. The timing controller 140 then generates the image data DATA, the first control signal CONT1 and the second control signal CONT2. The first control signal CONT1 may include, for example, a horizontal synchronization start signal STH for instructing start of an input of the image data DATA and a load signal TP controlling application of the data voltages D1 to Dm to the data lines DL1 to DLm. The second control signal CONT2 includes, for example, a scan start signal STV for instructing start of an output of the scan signals S1 to Sn and a gate clock signal CPV for controlling output timing of a scan on pulse.

The liquid crystal display device may further include a power supply unit which supplies operating power for the display device and a common voltage Vcom to the display panel 110 through a common line. The common line may be wiring for supplying the common voltage Vcom from the power supply unit to the common electrode of the display panel 110. The common line may extend in one direction along one side of the display panel 110. In this case, the common line may be formed, for example, on the upper substrate 20. The common line may be formed at a different location in another embodiment. Both the common voltage and the common electrode will be denoted by Vcom.

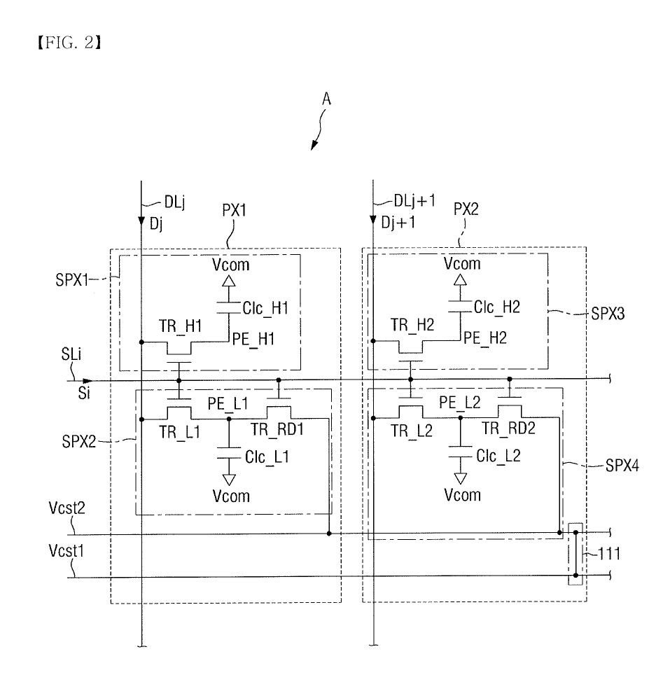

The pixel units PX in the display panel 110 include a first pixel unit PX1 and a second pixel unit PX2 connected to ith gate line SLi. The first pixel unit PX1 is connected to jth data line DLj and the second pixel unit PX2 is connected to kth data line DLk, where j≠A. The kth data line DLk is depicted as j+1th data line DLj+1, that is k=j+1 in FIGS. 1 and 2.

FIG. 2 illustrates an embodiment of an equivalent circuit for region A in FIG. 1. Referring to FIG. 2, the first pixel unit PXI includes first and second sub pixel units SPX1 and SPX2. The first and second sub pixel units SPX1 and SPX2 receive a jth data signal DLj to display images according to different gamma curves or display images according to the same gamma curve. For example, the first and second sub pixel units SPX1 and SPX2 may display images having different luminance to one data signal, thereby improving side visibility. The first and second sub pixel units SPX1 and SPX2 may have areas that are the same or different from each other.

The first sub pixel unit SPX1 includes a first high switching element TR_H1, a first high liquid crystal capacitor Clc_H1, and a first high storage capacitor. The first high switching element TR_H1 may be, for example, a transistor. The first high switching element TRH1 may have a gate electrode connected to ith gate line SLi, one electrode connected to jth data line DLj, and the other electrode connected to one electrode of the first high liquid crystal capacitor Clc_H1. One electrode of the first high switching element TR_H1 may be, for example, a source electrode. The other electrode of the first high switching element TR_H1 may be, for example, a drain electrode. The first high liquid crystal capacitor Clc_H1 may be between a first sub pixel electrode PE_H1, connected to the other electrode of the first high switching element TR_H1, and the common electrode Vcom. The first high storage capacitor may be between the first sub pixel electrode PE_H1 and a first storage line Vcst1.

The first high switching element TR_H1 is turned on in response to ith gate signal Si from ith gate line SLi, to provide jth data signal Dj from jth data line DLj to one electrode of the first high liquid crystal capacitor Clc_H1, that is, the first sub pixel electrode PE_H1. Thus, the first high liquid crystal capacitor Clc_H1 may be charged with a voltage difference between the voltage applied to the first sub pixel electrode PE_H1 and the common voltage applied to the common electrode Vcom.

The second sub pixel unit SPX2 includes a first low switching element TR_L1, a first distribution switching element TR_RD1, a first low liquid crystal capacitor Clc_L1, and a first low storage capacitor. The first low switching element TR_L1 and the first distribution switching element TR_RD1 may be, for example, a transistor. The first low switching element TR_L1 has a gate electrode connected to ith gate line SLi, one electrode connected to jth data line DLj, and the other electrode connected to one electrode of the first low liquid crystal capacitor Clc_L1. One electrode of the first low switching element TR_L1 may be, for example, a source electrode. The other electrode of the first low switching element TR_L1 may be, for example, a drain electrode.

The first distribution switching element TR_RD1 may have a gate electrode connected to ith gate line SLi, one electrode connected to the other electrode of the first low switching element TR_L1, and the other electrode connected to a second storage line Vcst2. One electrode of the first distribution switching element TR_RD1 may be, for example, a source electrode. The other electrode of the first distribution switching element TR_RD1 may be, for example, a drain electrode. The terms “high” and “low” as used herein may correspond to the relative locations of the switching and other elements described herein.

The first low liquid crystal capacitor Clc_L1 is between a second sub pixel electrode PE_L1, connected to the other electrode of the first low switching element TR_L1, and the common electrode Vcom. The first low storage capacitor is between the second sub pixel electrode PE_L1 and the first storage line Vcst1.

The first low switching element TR_L1 is turned on in response to ith gate signal Si from ith gate line SLi to provide jth data signal Dj from jth data line DLj to one electrode of the first low liquid crystal capacitor Clc_L1, that is, the second sub pixel electrode PE_L1.

The first distribution switching element TR_RD1 is turned on in response to ith gate signal Si from ith gate line SLi. Thus, the first low liquid crystal capacitor Clc_L1 may be charged with a voltage difference between the voltage applied to the second sub pixel electrode PE_L1 and the common voltage applied to the common electrode Vcom. At the same time, the voltage charged in the first low liquid crystal capacitor Clc_L1 may be divided through the turned-on first distribution switching element TR_RD1. Thus, the voltage charged in the first low liquid crystal capacitor Clc_L1 may be lowered by the difference between the common voltage Vcom and the voltage from the second storage line Vcst2.

The second pixel unit PX2 includes third and fourth sub pixel units SPX3 and SPX4. The third and fourth sub pixel units SPX3 and SPX4 receive j+1th data signal Dj+1 from j+1th data line DLj+1 to display images according to different gamma curves or display images according to the same gamma curve.

The third sub pixel unit SPX3 includes a second high switching element TR_H2, a second high liquid crystal capacitor Clc_H2, and a second high storage capacitor. The second high switching element TR_H2 may have a gate electrode connected to ith gate line SLi, one electrode connected to j+1th data line DLj+1, and the other electrode connected to one electrode of the second high liquid crystal capacitor Clc_H2. The second high liquid crystal capacitor Clc_H2 may be between a third sub pixel electrode PE_H2, connected to the other electrode of the second high switching element TR_H2, and the common electrode Vcom. The second high storage capacitor may be between the third sub pixel electrode PE_H2 and the first storage line Vcst1.

The second high switching element TR_H2 is turned on in response to ith gate signal Si to provide j+1th data signal Dj+1 from j+1th data line DLj+1 to one electrode of the second high liquid crystal capacitor Clc_H2, that is, the third sub pixel electrode PE_H2. Thus, the second high liquid crystal capacitor Clc_H2 may be charged with a voltage difference between the voltage applied to the third sub pixel electrode PE_H2 and the common voltage applied to the common electrode Vcom.

The fourth sub pixel unit SPX4 includes a second low switching element TR_L2, a second distribution switching element TR_RD2, a second low liquid crystal capacitor Clc_L2, and a second low storage capacitor. The second low switching element TR_L2 may have a gate electrode connected to ith gate line SLi, one electrode connected to j+1th data line DLj+1, and the other electrode connected to one electrode of the second low liquid crystal capacitor Clc_L2.

The second distribution switching element TR_RD2 has a gate electrode connected to ith gate line SLi, one electrode connected to the other electrode of the second low switching element TR_L2, and the other electrode connected to the second storage line Vcst2.

The second low liquid crystal capacitor Clc_L2 is between a fourth sub pixel electrode PE_L2 connected to the other electrode of the second low switching element TR_L2 and the common electrode Vcom. The second low storage capacitor is between the fourth sub pixel electrode PE_L2 and the first storage line Vcst1.

The second low switching element TR_L2 is turned on in response to ith gate signal Si from ith gate line SLi to provide j+1th data signal Dj+1 from j+1th data line DLj+1 to one electrode of the second low liquid crystal capacitor Clc_L2, that is, the fourth sub pixel electrode PE_L2.

The second distribution switching element TR_RD2 is turned on in response to ith gate signal Si. Thus, the second low liquid crystal capacitor Clc_L2 may be charged with a voltage difference between the voltage applied to the fourth sub pixel electrode PE_L2 and the common voltage applied to the common electrode Vcom. At the same time, the voltage charged in the second low liquid crystal capacitor Clc_L2 may be divided through the turned-on second distribution switching element TR_RD2. Thus, the voltage charged in the second low liquid crystal capacitor Clc_L2 may be lowered by the difference between the common voltage Vcom and the voltage from the second storage line Vcst2.

The jth and j+1th data signals Dj and Dj+1 may have, for example, different polarities. For example, if jth data signal Dj is a positive (+) polarity data signal, then j+1th data signal Dj+1 may be a negative (−) polarity data signal.

For example, the tilt angle of the liquid crystal molecules of the first and second sub pixel units SPX1 and SPX2 may vary according to the variation of the voltage charged in the first high liquid crystal capacitor Clc_H1 and the first low liquid crystal capacitor Clc_L1 of the first pixel unit PX1. Furthermore, the tilt angle of the liquid crystal molecules of the third and fourth sub pixel units SPX3 and SPX4 may vary according to the variation of the voltage charged in the second high liquid crystal capacitor Clc_H2 and the second low liquid crystal capacitor Clc_L2 of the second pixel unit PX2. Thus, the liquid crystal display device of the present embodiment may have improved visibility due to the variation of luminance between the sub pixel units.

Voltages having the same level may be applied to the first and second storage lines Vcst1 and Vcst2. The first and second storage lines Vcst1, Vcst2 may be in different layers and electrically interconnected through a connection unit 111. The connection unit 111 may be, for example, a contact hole. The first and second storage lines Vcst1 and Vcst2 are depicted in FIG. 2 as being electrically interconnected through the single connection unit 111, but lines Vcst1 and Vcst2 may be connected in a different manner in another embodiment.

The connection unit 111 may be in the second pixel unit PX2, in the first pixel unit PX1, or both the first and second pixel units PX1 and PX2. The first storage line Vcst1 may be made of, for example, the same material as the gate lines SL1 to SLn. The second storage line Vcst2 may be made of, for example, the same material as the first to fourth sub pixel electrodes PE_H1, PE L1, PE H2 and PE_L2. For example, the second storage line Vcst2 may be made of a transparent conductive material, e.g., ITO or IZO. Thus, the first storage line Vcst1 may have wiring resistance lower than that of the second storage line Vcst2.

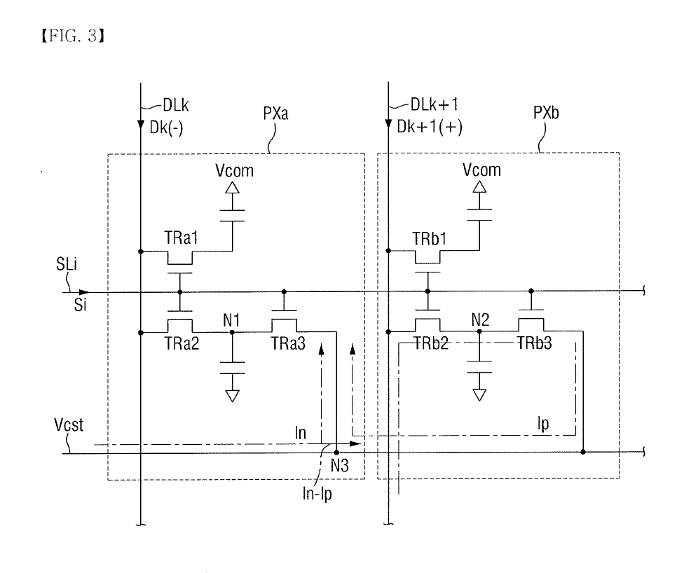

FIG. 3 illustrates one type of liquid crystal display device that includes an ath pixel unit PXa and a bth pixel unit PXb. The ath pixel unit PXa is connected to a kth data line DLk in order to receive kth data signal Dk. The bth pixel unit PXb is connected to k+1th data line DLk+1 in order to receive k+1th data signal Dk+1. The ath pixel unit PXa includes first to third switching elements TRa1 to TRa3. The third switching element TRa3 is connected to the storage line Vcst.

The bth pixel unit PXb includes fourth to sixth switching elements TRb1 to TRb3. The sixth switching element TRb3 is connected to the storage line Vcst. The kth data signal Dk is a negative (−) polarity signal and has a voltage level of 0V. The k+1th data signal Dk+1 is a positive (+) polarity signal and has a voltage level of 16V. The voltage level of the storage signal from the storage line Vcst is 8V.

The voltage of kth data signal Dk divided through the turned-on third switching element TRa3 may be applied to a first node N1 of the ath pixel unit PXa when the first switching element TRa1 is turned on. Thus, the voltage having a voltage level larger than 0V and smaller than 8V is applied to the first node N1. A first current path is therefore formed in the ath pixel unit PXa.

The voltage of k+1th data signal Dk+1 divided through the turned-on sixth switching element TRb6 is applied to a second node N2 of the bth pixel unit PXb when the fourth switching element TRb1 is turned on. Thus, the voltage having a voltage level larger than 8V and smaller than 16V is applied to the second node N2. A second current path Ip is therefore formed in the bth pixel unit PXb.

In this case, the first current path In and the second current path Ip are combined in a third node N3 in an attempt to compensate each other. However, asymmetrical current In-Ip which remains uncompensated may flow along the storage line Vcst. The asymmetrical current In-Ip will cause a voltage drop (IR-drop) phenomenon to occur based on the wiring resistance of the storage line Vcst.

Furthermore, the degree of voltage drop in the storage line Vcst may become greater, since the asymmetrical current In-Ip increases as it approaches the second direction d2 in FIG. 1 among the plurality of pixel units connected to the same gate line. Thus, the voltage levels of the storage signals provided to the pixel units connected to the same gate line may be different from each other. The voltage level of the storage signal applied to each pixel unit may therefore vary depending on the location of the pixel unit. As a result, horizontal crosstalk defects may occur in the liquid crystal display device, e.g., horizontal crosstalk defects may occur as a result of the voltage drop that results from the wiring resistance while asymmetrical current flows along the storage line Vcst.

In contrast, the liquid crystal display device in FIG. 2 may be configured so that the other electrode of each of the first and second distribution switching elements TR_RD1 and TR_RD2 is connected to the second storage line Vcst2. Also, the first storage line Vcst1 may be electrically connected to the second storage line Vcst2. Thus, since asymmetrical current flows toward the first storage line Vcst1 having a resistance relatively lower than the second storage line Vcst2, a voltage drop phenomenon caused by the asymmetrical current may not occur in the second storage line Vcst2 connected to the other electrode of each of the first and second distribution switching elements TR_RD1 and TR_RD2.

In this case, the connection unit 111, which interconnects the first and second storage lines Vcst1 and Vcst2, may be, for example, in the second pixel unit PX2, in the first pixel unit PX1, or in both pixel units PX1 and PX2.

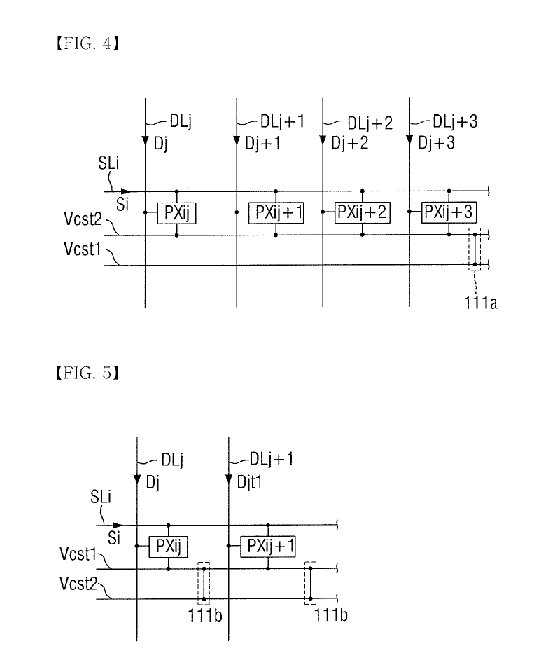

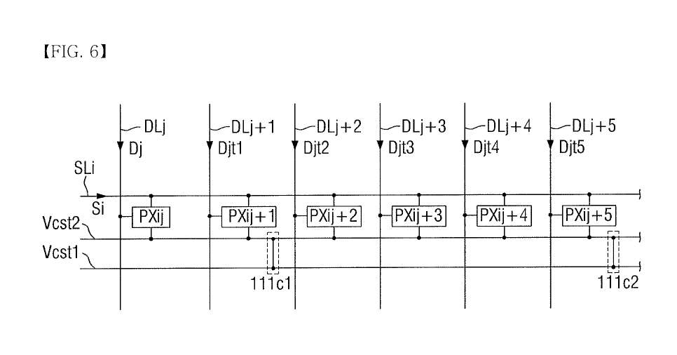

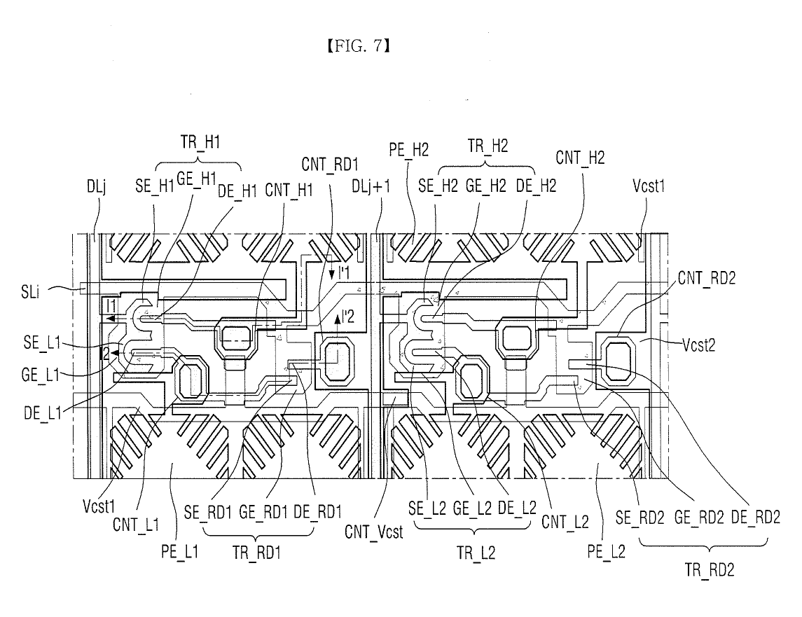

FIGS. 4 to 6 illustrate various embodiments of a pixel unit. In FIG. 4, the liquid crystal display device is configured so that a connection unit 111a is arranged about four pixel units PXij, PXij+1, PXij+2 and PXij+3. In FIG. 5, the liquid crystal display device is configured in that a connection unit 111b is arranged in both of the pixel units PXij and PXij+1. In another embodiment, the liquid crystal display device the connection unit may not be arranged about the same number of pixel units. Also, in FIG. 6, a first connection unit 111c1 may be disposed on a two pixel unit PXij and PXij+1 basis and a second connection unit 111c2 may be disposed on a four pixel unit PXij+2, PXij+3, PXij+4 and PXij+5 basis.

Thus, since the first storage line Vcst1 and the second storage line Vcst2 may be electrically interconnected, the asymmetrical current flows toward the first storage line Vcst1 to cause a voltage drop phenomenon in the second storage line Vcst2. The location or number of the connection units 111 may be different as described above, for example, as long as the voltage drop phenomenon caused due to the asymmetrical current does not occur in the second storage line Vcst.

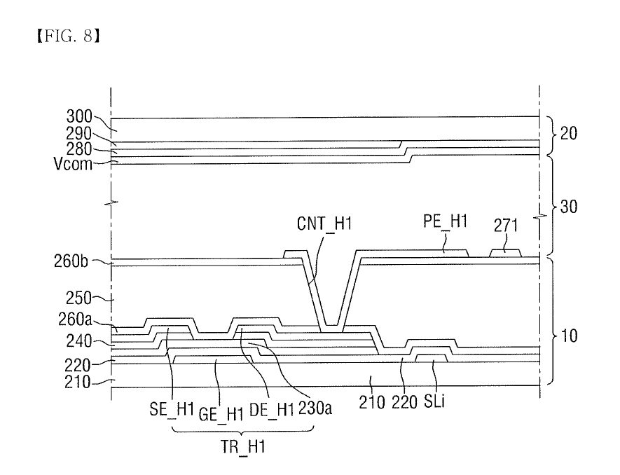

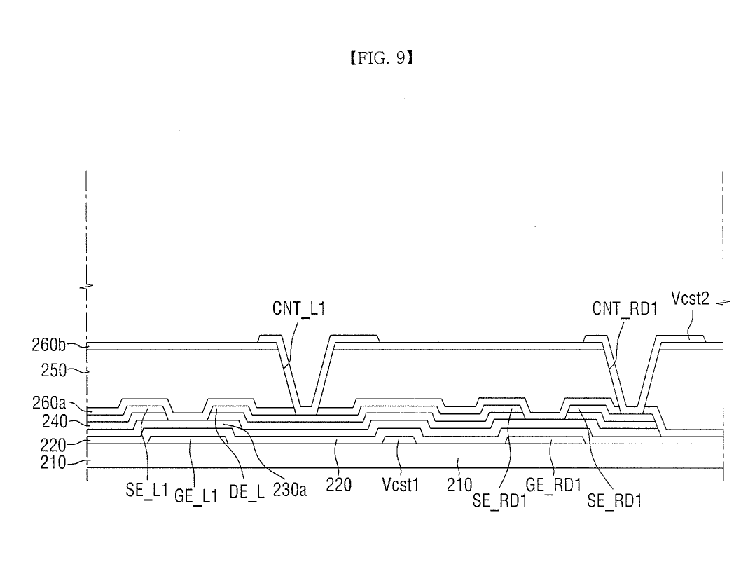

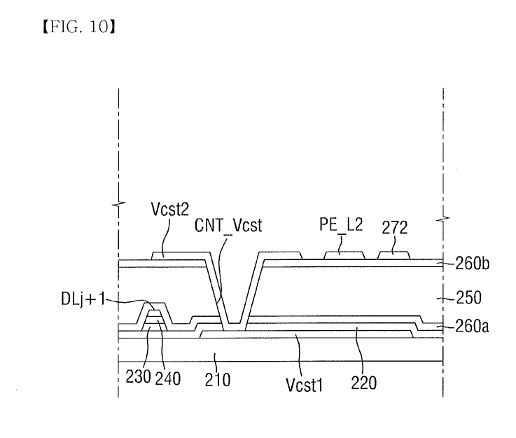

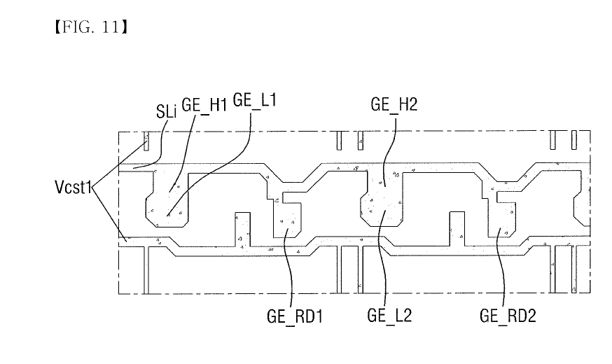

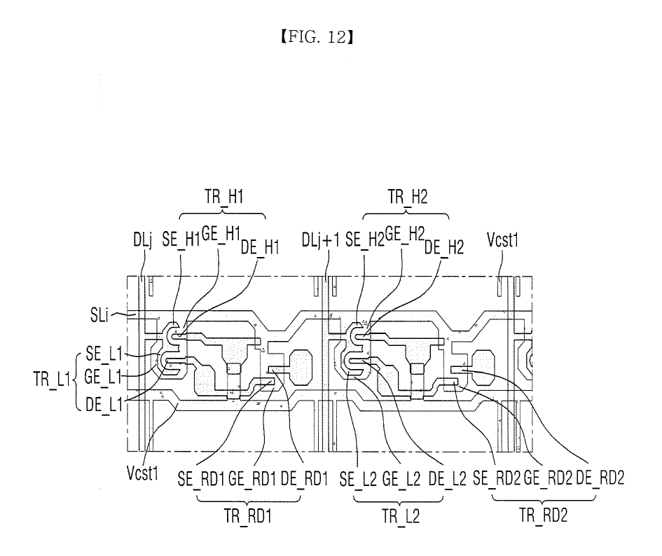

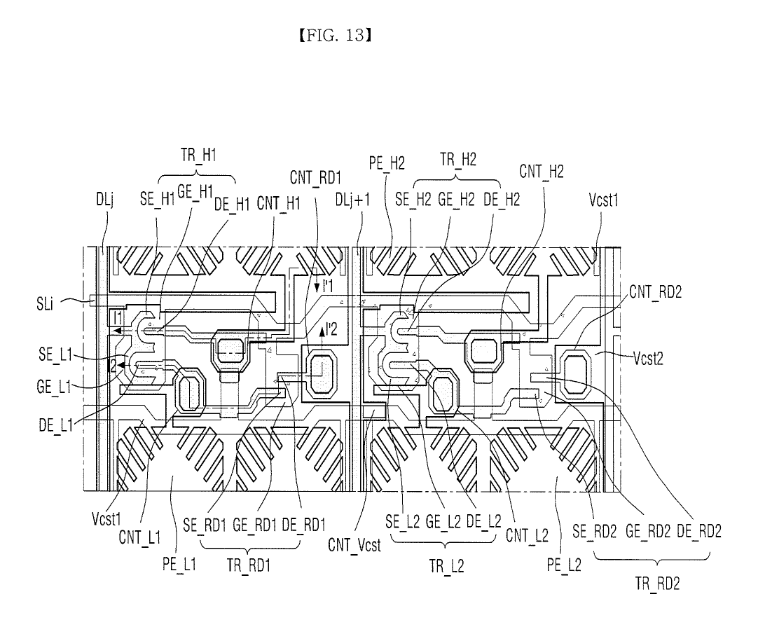

FIG. 7 illustrates a layout embodiment of region A in FIG. 1. FIG. 8 is a cross-sectional view taken along line I1-I1′ of FIG. 7. FIG. 9 is a cross-sectional view taken along line I2-I2′ of FIG. 7. FIG. 10 is a cross-sectional view taken along line I3-I3′ of FIG. 7. FIGS. 11 to 13 illustrate an embodiment of a method for forming region A in the layout diagram of FIG. 7.

For convenience, only the lower display plate 10 and components disposed on the lower display plate 10 are depicted in FIGS. 9 and 10. Furthermore, the connection unit 111 (refer to FIG. 2) may be, for example, a third contact hole CNT_Vcst. The third contact hole CNT_Vcst may be interposed, for example, between jth data line DLj and j+1th data line DLj+1. Meanwhile, a description will be made based on the first pixel unit PX1 in a structure where the arrangements of the first pixel unit PX1 and the second pixel unit PX2 are the same.

Referring to FIGS. 7 to 10, the liquid crystal display device includes the liquid crystal layer 30 between the lower display plate 10 and the upper display plate 20. The lower display plate 10 may be bonded to the upper display plate 20 through, for example, a sealing process.

A lower substrate 210 may be, for example, a glass substrate, a plastic substrate or a crystalline silicon (low temperature polysilicon (LTPS)) substrate, and may be an array substrate on which a plurality of switching elements are disposed. The ith gate line SLi and the first storage line Vcst1 may be on the lower substrate 210.

The ith gate line SLi includes first to third gate electrodes GE_H1, GE_L1 and GE_RD1. The ith gate line SLi may include a gate pad unit, and may be connected to another layer or an external driving circuit through the gate pad unit. The first storage line Vcst1 may be in the same layer as the ith gate line SLi, and the first storage line Vcst1 is insulated from the ith gate line SLi. The first storage line Vcst1 may be disposed such that at least a part thereof may overlap each of high and lower pixel electrodes of the first and second pixel units PX1 and PX2

A gate insulation layer 220 may be on the ith gate line SLi and the first storage line Vcst1. The gate insulation layer 220 may be made of, for example, silicon nitride (SiNₓ), silicon oxide (SiOₓ). The gate insulation layer 220 may have a multi-layer structure including at least two insulation layers having different physical properties.

A semiconductor layer including first to third semiconductor layers 230a, 230b and 230c may be on the gate insulation layer 220. Each of the first to third semiconductor layers 230a, 230b, and 230c may include, for example, amorphous silicon or crystalline silicon.

An ohmic contact layer 240 may be on the first to third semiconductor layers 230a, 230b, and 230c. The ohmic contact layer 240 may be made of silicide or a material such as n+ hydrogenated amorphous silicon heavily doped with n-type impurity such as phosphorus.

A data conductor including first to third source electrodes SE_H1, SE_L1 and SE_RD1 and first to third drain electrodes DE_H1, DE_L1 and DE_RD1 may be formed on the ohmic contact layer 240. The data conductor, the semiconductor layer, and the ohmic contact layer 240 may be formed simultaneously using a single mask.

Referring to FIGS. 7 and 8, the first gate electrode GE_H1, the first source electrode SE_H1, the first drain electrode DE_H1, and the first semiconductor layer 230a may form the first high switching element TR_H1. For example, the first source electrode SE_H1 may extend from the jth data line DLj and may have a shape enclosing at least a part of the first drain electrode DE_H1.

For example, the first source electrode SE_H1 may have one of a C shape, a U shape, an inverse C shape, and an inverse U shape. The first source electrode SE_H1 may be made of refractory metal such as molybdenum, chrome, tantalum and titanium or an alloy thereof, and may have a double-layer structure including a refractory metal layer and a low resistance conductive layer. In another embodiment, the first source electrode SE_H1 may be made of another type of metal or conductor.

The first drain electrode DE_H1 may be on the first gate electrode GE_H1 such that part of one side of the first drain electrode DE_H1 overlaps the first gate electrode GE_H1. Furthermore, the other side of the first drain electrode DE_H1 may be connected to the first sub pixel electrode PE_H1 through a first contact hole CNT_H1. The first drain electrode DE_H1 may include a material which is the same as that of the first source electrode SE_H1. In one embodiment, the first source electrode SE_H1 and the first drain electrode DE_H1 may be formed simultaneously through the same process. The first source electrode SE_HE the first drain electrode DE_H1, and the jth data line DLj may be formed in the same layer.

Referring to FIGS. 7 and 9, similar to the first high switching element TR_H1, the second gate electrode GE_L1, the second source electrode SE_L1, the second drain electrode DE_L2, and the second semiconductor layer 230b may form the first low switching element TR_L1. For example, the second source electrode SE_L1 may extend from the jth data line DLj and may have a shape enclosing at least a part of the second drain electrode DE_L1. For example, the second source electrode SE_L1 may have one of a C shape, a U shape, an inverse C shape, or an inverse U shape.

The second source electrode SE_L1 may be made of refractory metal such as molybdenum, chrome, tantalum and titanium or an alloy thereof, and may have a double-layer structure including a refractory metal layer and a low resistance conductive layer. The second source electrode SE_L1 may be made of another type of metal or conductor in another embodiment.

The second drain electrode DE_L1 may be formed on the second gate electrode GE_L1, such that a part of one side of the second drain electrode DE_L1 overlaps the second gate electrode GE_L1. Furthermore, the other side of the second drain electrode DE_L1 may be connected to the second sub pixel electrode PE_L1 through a second contact hole CNT_L1. The second drain electrode DE_L1 may include the same material as the second source electrode SE_L1. In one embodiment, the second source electrode SE_L1 and the second drain electrode DE_L1 may be formed simultaneously through the same process.

Referring to FIGS. 7 and 9, the third gate electrode GE_RD1, the third source electrode SE_RD1, the third drain electrode DE_RD1, and the third semiconductor layer 230c may form the first distribution switching element TR_RD1.

The third source electrode SE_RD1 and the third drain electrode DE_RD1, constituting the first distribution switching element TR_RD1, may be disposed on the ohmic contact layer 240 so that at least a part of the third source electrode SE_RD1 and the third drain electrode DE_RD1 overlap the third semiconductor layer 230c. The third source electrode SE_RD1 and the third drain electrode DE_RD1 may have, for example, an I shape.

A first passivation layer 260a may be formed on the data conductor including the first to third source electrodes SE_H1, SE_L1 and SE_RD1 and the first to third drain electrodes DE_H1, DE_L1 and DE_RD1, and on the exposed semiconductor layer. The first passivation layer 260a may be made of an inorganic insulating material such as silicon nitride and silicon oxide, or an organic insulating material. The first passivation layer 260a may prevent the pigment of a color filter 250 from being introduced into the exposed semiconductor portion.

The color filter 250 may be formed on the first passivation layer 260a. The color filter 250 may output one or more predetermined colors, such as three primary colors of red, green and blue colors. The color filter 250 may be made of a material that outputs different colors in every adjacent pixel.

A second passivation layer 260b may be on the color filter 250. The second passivation layer 260b may be made of an inorganic insulating material such as silicon nitride and silicon oxide, or an organic insulating material. The second passivation layer 260b may prevent an upper portion of the color filter 250 from being separated, and may inhibit the liquid crystal layer 30 from being contaminated by an organic material such as a solvent introduced from the color filter 250 in order to prevent defects (such as afterimage) which might otherwise occur when driving a screen.

The first contact hole CNT_H1 for exposing the first drain electrode DE_H1 and the second contact hole CNT_L1 for exposing the second drain electrode DE_L1 may be formed on the first passivation layer 260a and the second passivation layer 260b. Furthermore, referring to FIG. 10, a third contact hole CNT_Vcst for exposing the first storage line Vcst1 may be formed in the first passivation layer 260a and the second passivation layer 260b.

Thus, the first drain electrode DE_H1 may be electrically connected to the first sub pixel electrode PE_H1 through the first contact hole CNT_H1. The second drain electrode DE_L1 may be electrically connected to the second sub pixel electrode PE_L1 through the second contact hole CNT_L1. The third drain electrode DE_RD1 may be electrically connected to the second storage line Vcst2 through the third contact hole CNT_Vcst. The first storage line Vcst1 may be electrically connected to the second storage line Vcst2 through the third contact hole CNT_Vcst. Thus, asymmetrical current generated in the second storage line Vcst2 may flow along the first storage line Vcst1, thereby preventing a voltage drop phenomenon from occurring in the second storage line Vcst2 as a result of the asymmetrical current.

The first sub pixel electrode PE_H1, the second sub pixel electrode PE_L1, and the second storage line Vcst2 may be on the second passivation layer 260b. The first and second sub pixel electrodes PE_H1 and PE_L1 may be made of a transparent conductive material such as ITO and IZO, or reflective metal such as aluminum, silver, chrome or an alloy thereof. The first sub pixel electrode PE_H1 and the second sub pixel electrode PE_L1 may have, for example, an overall square shape and may include, for example, a cross-shaped stem portion having a plurality of horizontal stems and a plurality of vertical stems intersecting the horizontal stems.

Furthermore, a sub region divided by the plurality of horizontal stems and the plurality of vertical stems may include a plurality of fine branches 272. The first sub pixel electrode PE_H1 may receive jth data signal Dj from the first drain electrode DE_H1. The second sub pixel electrode PE_L1 may receive jth data signal Dj from the second drain electrode DE_L1. However, part of the voltage of the applied jth data signal Dj may be divided to the third source electrode SE_RD1 as the first distribution switching element TR_RD1 is turned on. Thus, the magnitude of the voltage applied to the second sub pixel electrode PE _L1 may be lower than the magnitude of the voltage applied to the first sub pixel electrode PE_H1.

As a result, the direction of the liquid crystal molecules between the first sub pixel electrode PE_H1 and the common electrode Vcom may be different from the direction of the liquid crystal molecules between the second sub pixel electrode PE_L1 and the common electrode Vcom. Thus, the luminance of light may differ, thereby improving side visibility.

The second storage line Vcst2 may be made of a transparent conductive material such as ITO and IZO, or reflective metal such as aluminum, silver, chrome or an alloy thereof. The second storage line Vcst2 may be disposed on the other data lines in addition to the jth and j+1th data lines DLj and DLj+1, such that the second storage line Vcst2 overlaps the other data lines. Thus, the second storage line Vcst2 may serve as a light blocking member for preventing light leakage from a peripheral region such as a plurality of data lines DL1 to DLm.

In one embodiment, a lower alignment layer may be formed on the first sub pixel electrode PE_H1 and the second sub pixel electrode PE_L1.

An upper substrate 300 may be made of transparent glass, plastic or the like. A light blocking member 290 (e.g., a black matrix) may prevent light leakage. An overcoat layer 280 may be on the upper substrate 300 and the light blocking member 290. The overcoat layer 280 may be made of an insulating material and may be omitted in another embodiment. The common electrode Vcom may be disposed on the overcoat layer 280. An upper alignment layer may be formed on the common electrode Vcom.

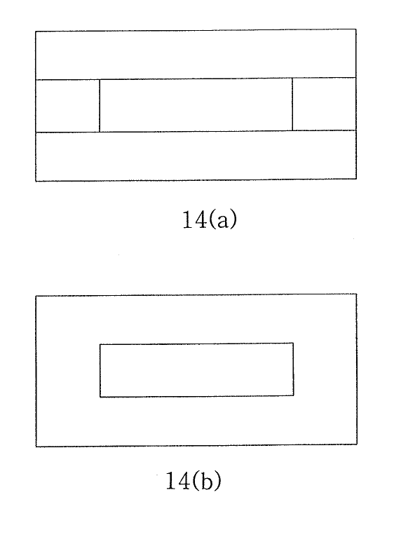

FIG. 14(a) illustrates the occurrence of horizontal crosstalk in one type of liquid crystal display device that has been proposed, and FIG. 14(b) illustrates improvement in horizontal crosstalk at least one embodiment of in the liquid crystal display herein.

Referring to FIG. 14(a), asymmetrical current flows along the storage line Vcst and causes a voltage drop phenomenon based on wiring resistance as described with reference to FIG. 3. Accordingly, the level of the voltage applied from the storage line Vcst may vary for each location of the pixel unit and horizontal crosstalk is caused by luminance change.

Referring to FIG. 14(b), asymmetrical current generated from the second storage line Vcst2 flows to the first storage line Vcst1, which is electrically connected to the second storage line Vcst2 through the third contact hole CNT_Vcst and which has relatively lower resistance. As a result, a voltage drop phenomenon may be reduced or prevented from occurring in the second storage line Vcst2 and, accordingly, horizontal crosstalk described may be reduced or prevented.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A liquid crystal display device, comprising:
a gate driver connected to an ith gate line;
a first storage line in a same layer as the ith gate line; and
a display panel having first and second pixel units connected to the ith gate line, wherein the first pixel unit includes a first high switch, a first low switch, and a first distribution switch connected to the ith gate line, and the second pixel unit includes a second high switch, a second low switch, and a second distribution switch connected to the ith gate line,
wherein the first distribution switch has a first electrode connected to the first low switch and a second electrode connected to a second storage line, and the second distribution switch has a first electrode connected to the second low switch and a second electrode connected to the second storage line, and
wherein the second storage line is in a different layer from the first storage line and is connected to the first storage line.

2. The device as claimed in claim 1, wherein the second storage line is connected to the first storage line through at least one contact hole.

3. The device as claimed in claim 1, wherein the same voltage is to be applied to the first and second storage lines.

4. The device as claimed in claim 1, wherein:
the first high switch has a first electrode connected to a jth data line and a second electrode connected to a first sub pixel electrode,
the first low switch has a first electrode connected to the jth data line and a second electrode connected to a second sub pixel electrode,
the second high switch has a first electrode connected to a kth data line and a second electrode connected to a third sub pixel electrode, and
the second low switch has a first electrode connected to the kth data line and a second electrode connected to a fourth sub pixel electrode.

5. The device as claimed in claim 4, wherein the kth data line is between the first high switch and the second high switch.

6. The device as claimed in claim 4, wherein a data signal to be applied to the jth data line and a data signal to be applied to the kth data line have different polarities.

7. The device as claimed in claim 4, wherein the second storage line is in a same layer as at least one of the first to fourth sub pixel electrodes.

8. The device as claimed in claim 4, wherein at least part of the second storage line overlaps the jth and kth data lines.

9. A liquid crystal display device, comprising:
a gate driver connected to a plurality of gate lines;
a data driver connected to a plurality of data lines;
a first storage line in a same layer as the gate lines; and
a display panel having a plurality of pixel units including first to third switches connected to an ith gate line among the gate lines, wherein each of the pixel units includes a high pixel electrode connected to a first electrode of the first switch and a low pixel electrode connected to a first electrode of the second switch,
wherein the third switch in the pixel units has a first electrode connected to a first electrode of the second switch and a second electrode connected to a second storage line, and
wherein the second storage line is in a different layer from the first storage line and is connected to the first storage line.

10. The device as claimed in claim 9, wherein the first storage line is connected to the second storage line through at least one contact hole.

11. The device as claimed in claim 9, wherein the first and second storage lines are to receive a same voltage.

12. The device as claimed in claim 9, wherein:
the pixel units are connected to respective ones of the data lines,
the pixel units include a first pixel unit connected to a jth data line and a second pixel unit connected to a j+1th data line, and
the first storage line is connected to the second storage line through a contact hole in at least one of the first pixel unit or the second pixel unit.

13. The device as claimed in claim 12, wherein the jth data line and the j+1th data line are to receive data signals having different polarities.

14. The device as claimed in claim 12, wherein at least part of the second storage line overlaps the jth data line and the j+1th data line.

15. A liquid crystal display device, comprising:
a first pixel unit having a first high pixel unit to apply a jth data signal to a first sub pixel electrode in response to an ith gate signal, and a first low pixel unit to apply the jth data signal and a storage signal to a second sub pixel electrode in response to the ith gate signal;
a second pixel unit having a second high pixel unit to apply a kth data signal to a third sub pixel electrode in response to the ith gate signal, and a second low pixel unit to apply the kth data signal and the storage signal to a fourth sub pixel electrode in response to the ith gate signal;
a first storage line connected to the first and second low pixel units, the first storage line to provide the storage signal; and
a second storage line in a different layer from a layer of the first storage line, the second storage line connected to the first storage line.

16. The device as claimed in claim 15, wherein:
the second storage line is in a same layer as the first to fourth sub pixel electrodes, and
the first storage line is in a same layer as a layer of an ith gate line which is to provide the ith gate signal.

17. The device as claimed in claim 15, wherein first storage line and the second storage line are to receive a same voltage.

18. The device as claimed in claim 15, wherein the first storage line and the second storage line are electrically connected through at least one contact hole.

19. The device as claimed in claim 15, further comprising:
a gate driver connected to an ith gate line which is to provide the ith gate signal; and
a data driver connected respectively to a jth data line which is to provide the jth data signal and a kth data line which is to provide the kth data signal.

20. The device as claimed in claim 19, wherein:
the first low pixel unit includes a first low switch having a gate electrode connected to the ith gate line, a first electrode connected to the jth data line, and a second electrode connected to the second sub pixel electrode, and a first distribution switch having a gate electrode connected to the ith gate line, a first electrode connected to the second sub pixel electrode, and a second electrode connected to the second storage line, and
the second low pixel unit includes a second low switch having a gate electrode connected to the ith gate line, a first electrode connected to the kth data line, and a second electrode connected to the fourth sub pixel electrode, and a second distribution switch having a gate electrode connected to the ith gate line, a first electrode connected to the fourth sub pixel electrode, and a second electrode connected to the second storage line.
